(19) United States
(12) Patent Application Publication
(10) Pub. No.: US 2026/0235220 A1
(43) Pub. Date: Aug. 13, 2026

(54) FILLING VALVE ASSEMBLY WITH BAYONET MOUNT FOR BOTTLE ALIGNMENT COMPONENT

(71) Applicant: Fogg Filler Company, LLC, Holland, MI (US)

(72) Inventors: Randall JOHNSON, Grand Haven, MI (US); Todd KEMME, Jenison, MI (US)

(21) Appl. No.: 19/450,005

(22) Filed: Jan. 15, 2026

Related U.S. Application Data
(60) Provisional application No. 63/755,628, filed on Feb. 7, 2025.

(51) Int. Cl. F16K 21/00; B67C 3/28; F16K 27/02

(52) U.S. Cl. CPC F16K 21/00; B67C 3/28; F16K 27/02

(57) ABSTRACT

A fill valve assembly includes a bayonet mount assembly including a connection opening and a container alignment component releasably connected to the bayonet mount assembly. The container alignment component includes a connection portion disposed within the connection opening and in a first rotational position that prevents axial movement of the connection portion out of the connection opening. The bayonet mount assembly includes a locking part in a locking position in which a portion of the locking part interacts with a part of the connection portion so as to prevent a rotation of the container alignment component from the first rotational position to a second rotational position that allows axial movement of the connection portion out of the connection opening. The locking part is movable to an unlocking position that allows the rotation of the container alignment component from the first rotational position to the second rotational position.

### TECHNICAL FIELD

This application relates generally to filling machines used to fill liquid into containers and, more specifically, to a bayonet mount for such a filling valve assembly and a filling valve assembly including such a bayonet mount.

### BACKGROUND

A typical liquid filling system for containers includes a container handling device, a liquid filling machine and a capping/lidding machine. The container handling device transports unfilled containers to the liquid filling machine and then transports the filled containers from the filling machine to the capping/lidding machine. The container handling device commonly comprises one or more conveyors and may also include one or more indexing devices such as gates, star wheels or spindles.

One type of rotary filling machine includes a plurality of filling stations arranged around the circumference of a revolving filler bowl that holds the liquid to be filled into containers. Each filling station includes a filling device typically having a filling valve, with associated nozzle, and a container/bottle alignment component that helps guide the container into proper position relative to the filling valve for filling. The valve operates to control the feed of material down through the nozzle into the container. The nozzles direct liquid product into the container. The liquid product may be delivered to the nozzles from the filler bowl by gravity feed.

The configuration of the container/bottle alignment component varies based upon container configuration. Therefore, when a filling machine is used for filling of multiple different container configurations, it may be necessary to change out the container/bottle alignment component of each filling valve when a change from use of the filling machine for filling of one container configuration to use of the filling machine for filling a different container configuration is made. This change-out can be labor intensive and time consuming.

Accordingly, it would be desirable to provide a filling valve assembly that is configured to more quickly enable changeout of the container alignment component.

In one aspect, a fill valve assembly for use in association with a filler device is provided. The fill valve assembly includes a bayonet mount assembly including a connection opening and a container alignment component releasably connected to the bayonet mount assembly, wherein the container alignment component includes a connection portion disposed within the connection opening and in a first rotational position, relative to the bayonet mount assembly, that prevents axial movement of the connection portion out of the connection opening. The bayonet mount assembly includes a locking part in a locking position in which a portion of the locking part interacts with a part of the connection portion of the container alignment component so as to prevent a rotation of the container alignment component from the first rotational position to a second rotational position that allows axial movement of the connection portion out of the connection opening. The locking part is manually movable to an unlocking position that allows the rotation of the container alignment component from the first rotational position to the second rotational position.

In another aspect, a fill valve assembly for use in association with a filler device is provided. The fill valve assembly includes a bayonet mount assembly including a connection opening and a container alignment component releasably connected to the bayonet mount assembly, wherein the container alignment component includes a connection portion disposed within the connection opening. The connection opening of the bayonet mount assembly includes at least one retaining ledge and the connection portion of the container alignment component includes at least one retaining tab. The container alignment component is in a first rotational position relative to the bayonet mount assembly and in which the at least one retaining tab is engaged on the at least one retaining ledge to prevent the container alignment component from separating from the bayonet mount assembly by axial movement of the connection portion in a first direction out of the connection opening. The bayonet mount assembly includes a locking part in a locking position in which a portion of the locking part interacts with a part of the connection portion so as to prevent a rotation of the container alignment component from the first rotational position to a second rotational position that rotationally offsets the at least one retaining tab from the at least one retaining edge. The locking part is axially movable to an unlocking position that axially offsets the portion of the locking part from the part of the connection portion so as to allow the rotation of the container alignment component from the first rotational position to the second rotational position such that the container alignment component can be separated from the bayonet mount assembly by axial movement of the connection portion in the first direction out of the connection opening.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1-2 show perspective views of a bayonet mount assembly and associated container alignment component;

FIGS. 3-4 show perspective views with parts of the bayonet mount assembly shown as transparent;

FIGS. 5-6 show the bayonet mount assembly and container alignment component separated with the container alignment component in a position for insertion into the bayonet mount assembly;

FIGS. 7-8 show the bayonet mount assembly and container alignment component separated with the container alignment component in a position that would not allow insertion into the bayonet mount assembly;

FIG. 9 shows a cross-section view with the locking part in a locking position;

FIG. 10 shows an exploded view with the locking part in the locking position relative to the container alignment component;

FIG. 11 shows a cross-section view with the locking part in an unlocking position;

FIG. 12 shows an exploded view with the locking part in the unlocking position relative to the container alignment component;

FIG. 13 shows a cross-section view;

FIG. 14 shows a partially exploded view of the bayonet mount assembly with the locking component in the locking position;

FIG. 15 shows a partially exploded view of the bayonet mount assembly with the locking component in the unlocking position;

FIG. 16 shows a perspective partial view with the upper cap of the bayonet mount assembly hidden and with the container alignment component rotated to a position for removal;

FIG. 17 shows a perspective view of a filling valve including the bayonet mount assembly;

FIGS. 18-20 show cross-section views; and

FIG. 21 shows an exploded perspective of the bayonet mount assembly and container alignment component of FIG. 17.

### DETAILED DESCRIPTION

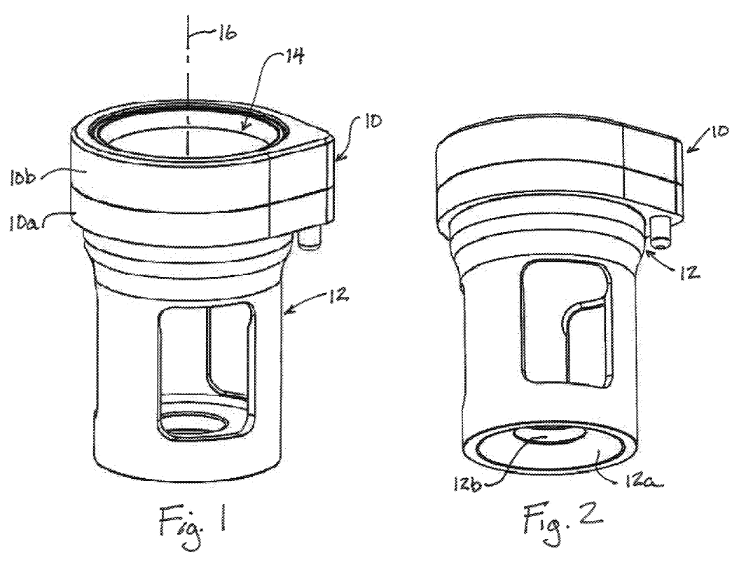

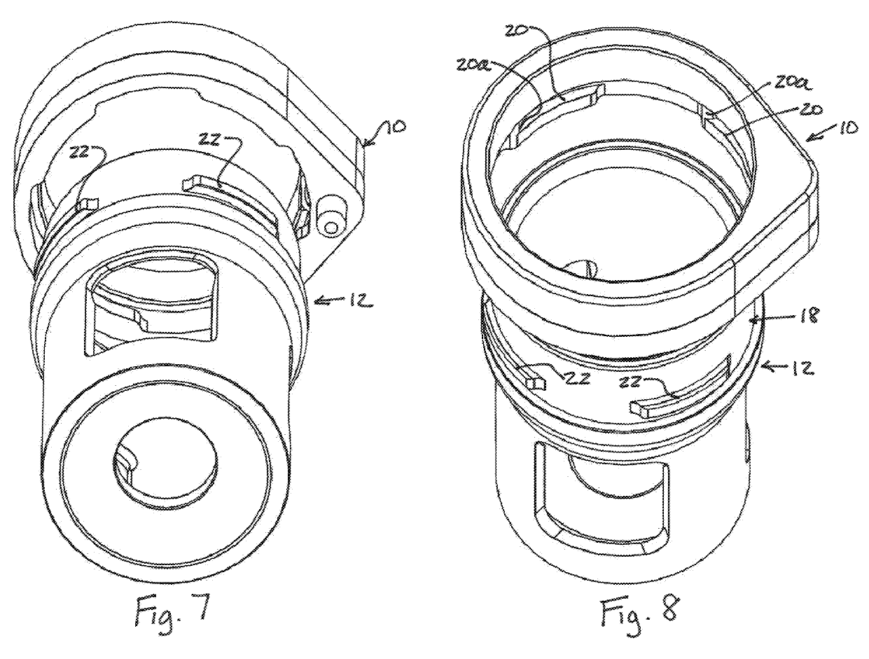

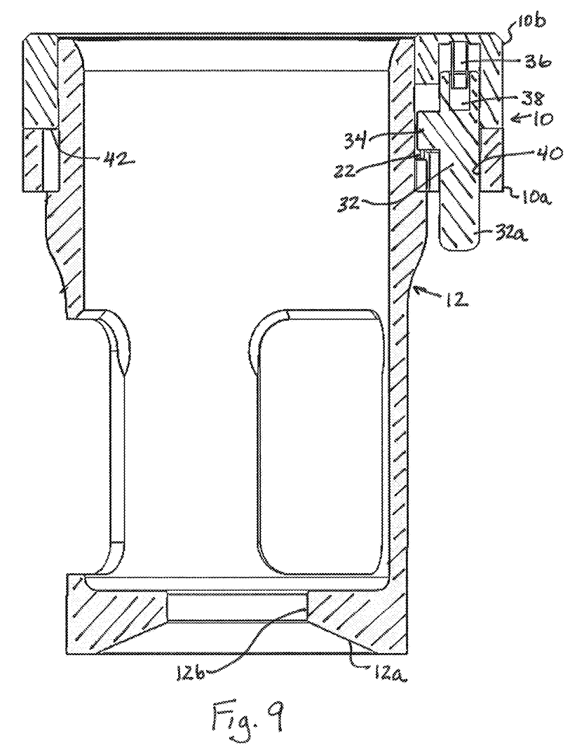

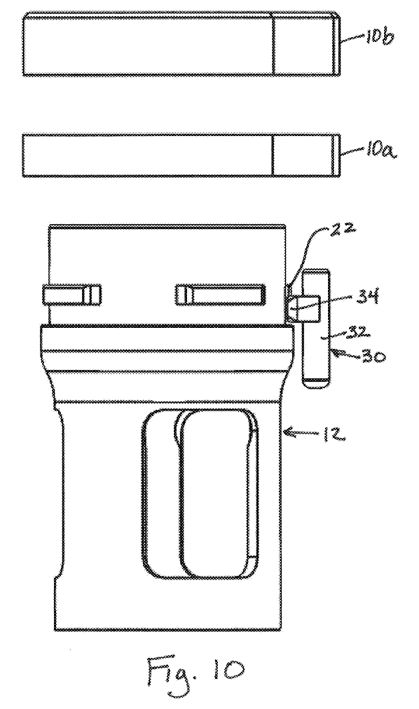

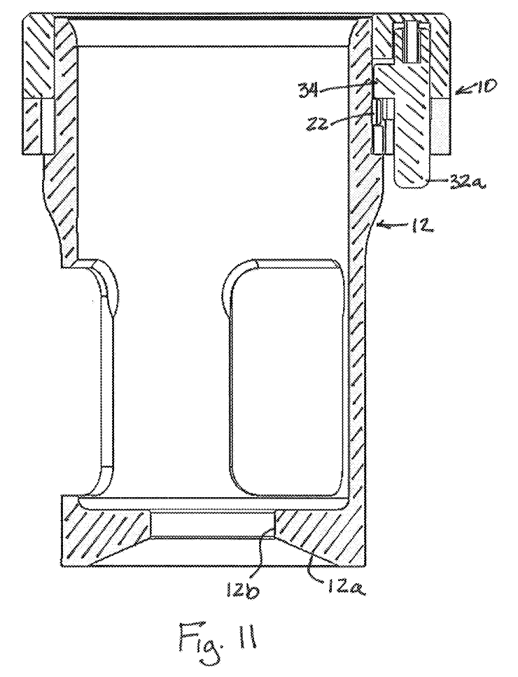

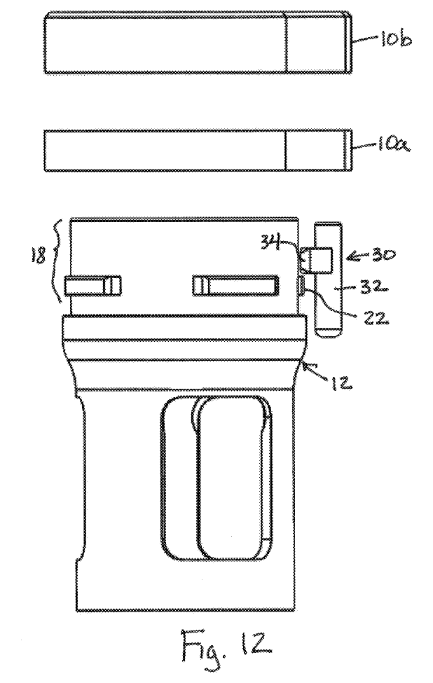

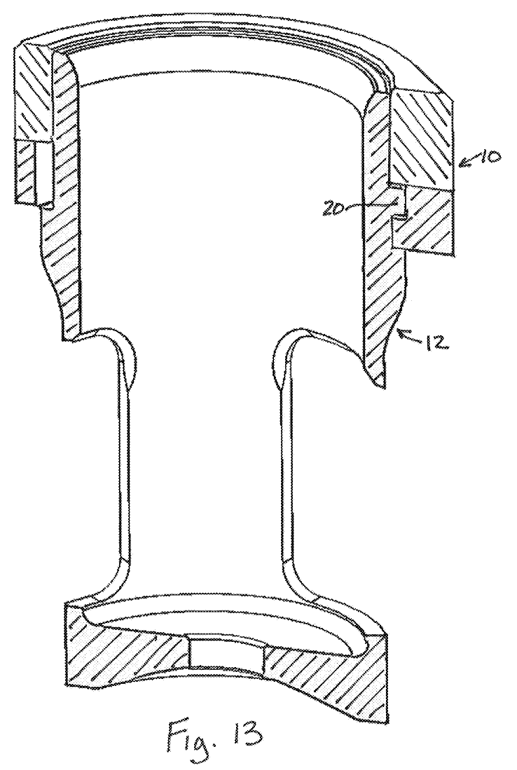

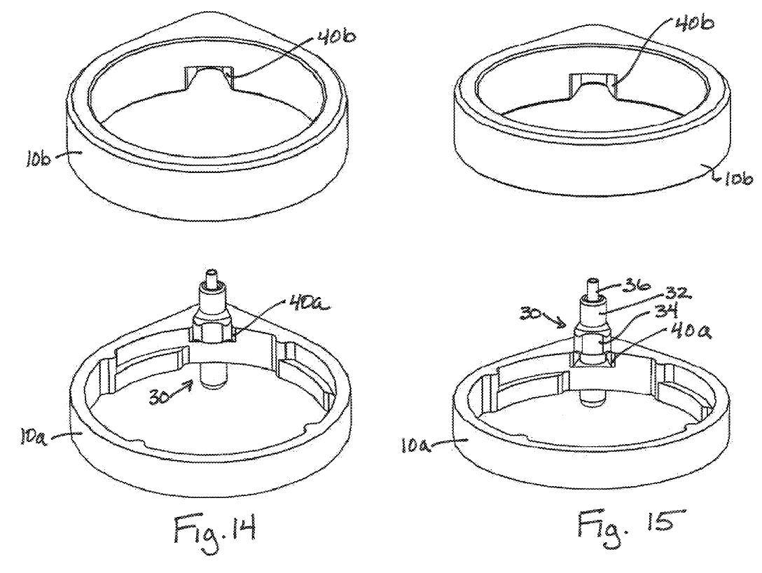

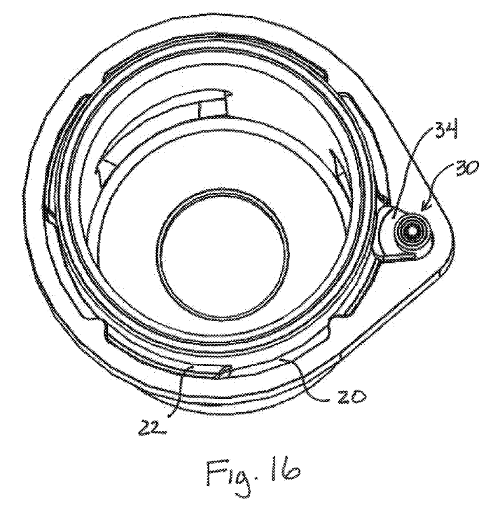

Referring to FIGS. 1-16, a bayonet mount assembly 10 for use in connecting with a filling valve that utilizes a container alignment component 12 is shown. The bayonet mount assembly 10 includes a connection opening 14 disposed around an axis 16 of the bayonet mount assembly. The container alignment component 12 (e.g., a bottle neck guide) is releasably connected to the bayonet mount assembly 10. The container alignment component 12 includes an upper connection portion 18 disposed within the connection opening 14, and a lower end with a tapered surface 12a that leads to a central opening 12b and that can engage with the upper end of a container to help align the bottle with a filling valve.

The connection opening 14 of the bayonet mount assembly includes at least one radially inwardly extending retaining ledge 20 and the connection portion 18 of the container alignment component includes at least one radially outward extending retaining tab or lug 22. Here, four equally spaced apart circumferentially running retaining ledges 20 and four equally spaced apart circumferentially running retaining tabs 22 are provided, but the number could vary.

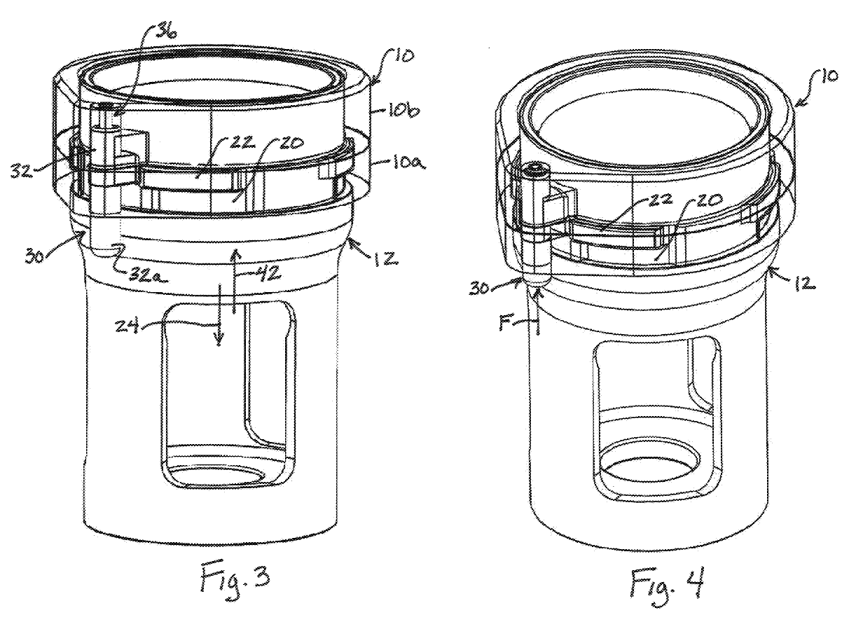

In a connected and locked position of the container alignment component 12 (per FIG. 3), the container alignment component 12 is in a locked rotational position relative to the bayonet mount assembly 10 in which the retaining tabs 22 are engaged on the retaining ledges 20 to prevent the container alignment component 12 from separating from the bayonet mount assembly 10 by axial movement of the connection portion 18 in a direction 24 out of the connection opening 14. Specifically, the retaining ledges 20 overlap with the retaining tabs 22 to block the axial movement in the direction 24.

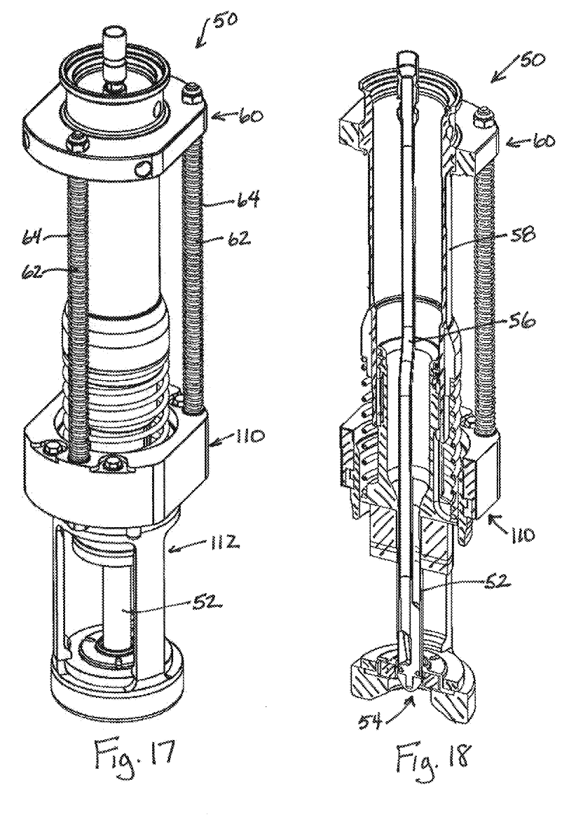

The bayonet mount assembly includes a locking part 30, here comprised by a locking pin 32 with a protruding locking detent 34, in a locking position (FIG. 3) in which the locking part 30, specifically the locking detent 34, which protrudes radially inward toward the axis 16 of the bayonet mount assembly, is positioned to interact with an adjacent one of the retaining tabs 22 so as to prevent a rotation of the container alignment component 12 from the locked rotational position to an unlocked rotational position (FIG. 16) that rotationally offsets the retaining tabs 22 from the retaining ledges 20. The locking part 30 is axially movable to an unlocking position (FIG. 4) that axially offsets the locking detent 34 from the adjacent retaining tab 22 so as to allow the rotation of the container alignment component 12 from the locked rotational position of FIG. 3 to the unlocked rotational position of FIG. 16 by enabling the adjacent retaining tab 22 to pass beneath the locking detent 34. In this unlocked rotational position, the retaining tabs 22 have clearance to exit the connection opening 14 such that the container alignment component 12 can be separated from the bayonet mount assembly 10 by axial movement of the connection portion 18 in the direction 24 out of the connection opening 14.

The locking pin 32 is axially biased into the locking position (FIG. 3) by a biasing member 36 and is movable to the unlocking position (FIG. 4) by application of an axial force F on the pin that overcomes the bias of the biasing member. Here, the biasing member is an axial spring that seats in an upper end opening 38 of the locking pin 32. However, alternative biasing members could be utilized. A lower portion 32a of the pin protrudes downwardly from a pin passage 40 of the bayonet mount assembly 10. Here, the bayonet mount assembly 10 is formed by a lower retaining plate 10a and an upper cap 10b engaged with the lower retaining plate 10a, and the pin passage 40 is formed in part on the lower retaining plate 10a and in part on the upper cap 10b. The retaining plate 10a and upper cap 10b may be secured together in any suitable manner (e.g., fasteners, welding or other). The upper cap 10b is configured interact with the retaining tabs 22 to limit axial movement of the connection portion 18 in a direction 42 that is opposite the direction 24. For this purpose, the upper cap 10b defines a downwardly facing annular ledge 44. The container alignment component 12 also includes an upwardly facing annular ledge 12c that will seat against the bottom edge of the bayonet mount assembly 10 to limit the upward axial movement of the container alignment component 12.

Here, the locking detent 34 is a pie-shaped protrusion from the pin 32, and the pin passage 40 includes aligned pie-shaped portions 40a and 40b on the retaining plate 10a and the upper cap 10b to accommodate the detent and its axial movement.

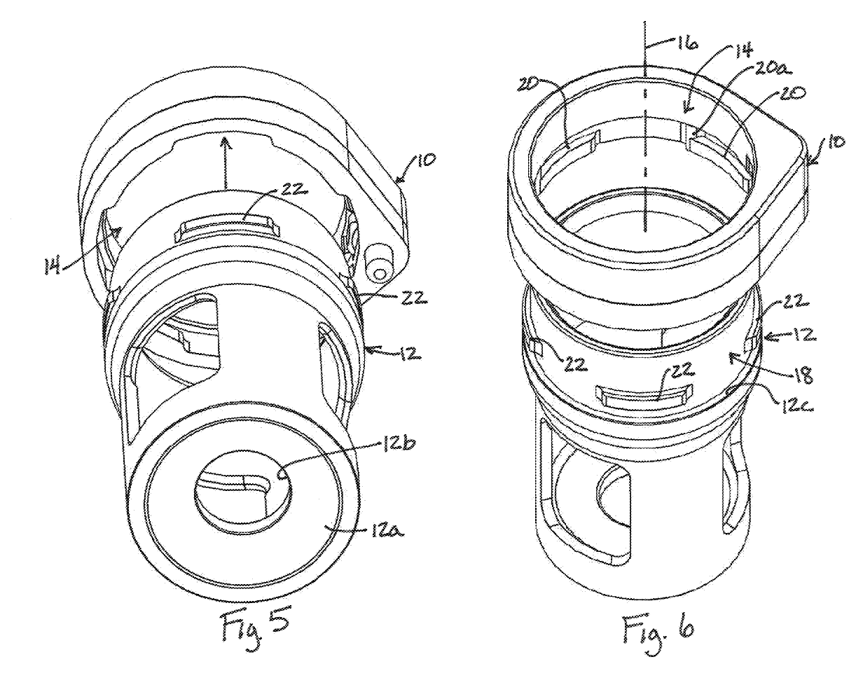

In terms of connection and removal of the container alignment component 12 to the bayonet mount assembly 10, FIGS. 5-6 show a rotational position of the container alignment component 12 relative to the bayonet alignment assembly 10 that allows the connection portion 18 to move into and out of the connection opening 14. Once the connection portion 18 is inserted into the connection opening 14, the locking part 30 is pushed upward to its unlocking position to allow rotation of the connection portion 18 to place the retaining tabs 22 over the retaining ledges 20. Once the retaining tab 22 moves past the locking detent 34, the locking part 30 will be moved back down to its locking position under the bias of the spring. End stops 20a are located at one end of the retaining ledges 20 to limit the rotation of the container alignment component 12.

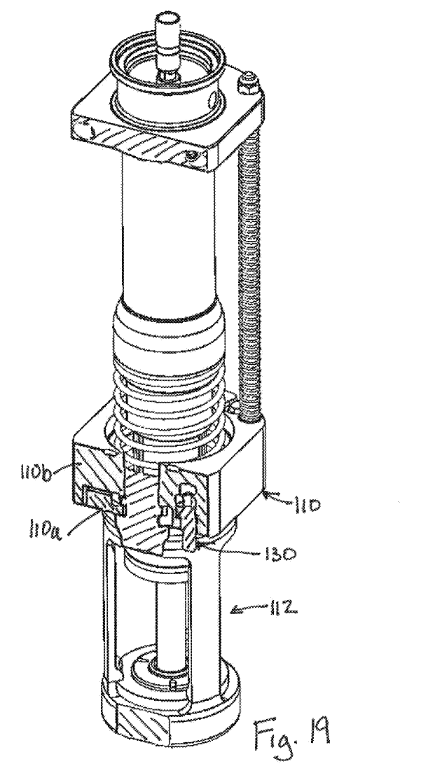

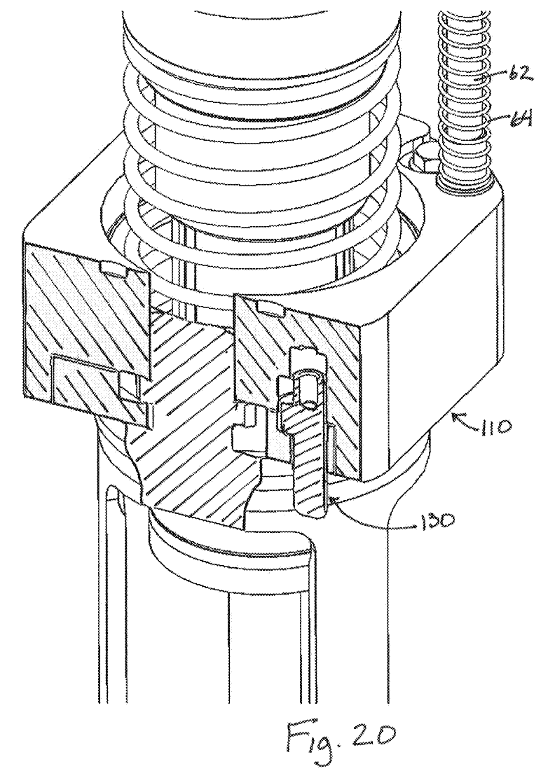

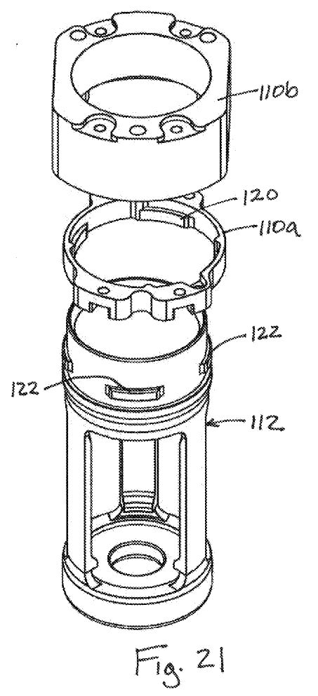

As mentioned above, the bayonet mount assembly is useful in connection with filling valves. By way of example, FIGS. 17-21 show one exemplary implementation of the bayonet mount assembly on a filling valve 50 having a tubular sleeve 52 with an end nozzle 54 which may define a liquid outlet and an air inlet. The nozzle tip is connected at the lower end of a vent tube 56, and the air inlet is formed at a lower portion of the vent tube. The vent tube 56 extends upwardly through a housing 58 of the filling valve. In use, the filling valve 50 is typically connected to an opening in a bottom wall of a filler bowl that holds the liquid that can move down through the housing 58 for the purpose of container filling.

Here, the filling valve 50 includes an upper end 60 and the bayonet mount assembly 110 is mounted for axial movement along the fill valve assembly between a lower start position and a raised position, by sliding along guide rods 62 that include springs 64 to bias the bayonet mount assembly 110 downward to the start position. The bayonet mount assembly 110 is located further from the upper end 60 when the bayonet mount assembly in the start position than when the bayonet mount assembly is in the raised position.

Notably, the shape of the bayonet mount assembly 110 is different than the bayonet mount assembly 10 described above. However, the bayonet mount assembly 110 is functionally the same and formed by a lower retaining plate 110a with retaining ledges 120 and an upper cap member 110b, and also includes a similar axially movable locking part 130 (e.g., locking part 130 is similarly configured to locking part 30 above, and locking part 130 is similarly movable between locking and locking positions). The container alignment component 112 includes the retaining tabs 122.

The described bayonet mount for container alignment component facilitates quick changeover between differing container runs that require differing container alignment components. The bayonet mount assembly operates as a quick-change connection for the container alignment components.

It is to be clearly understood that the above description is intended by way of illustration and example only, is not intended to be taken by way of limitation, and that other changes and modifications are possible. For example, embodiments in which the bayonet mount assembly structure has different shapes are possible. Further, embodiments in which the locking detent interacts with another part of the connection portion of the container alignment component are also possible (e.g., the locking detent interacts with some other projecting part or feature on the connection portion). Moreover, the bayonet mount assembly could be used for mounting of other components on container rinsing/filling/capping equipment.

1. A fill valve assembly for use in association with a filler device, the fill valve assembly comprising:
a bayonet mount assembly including a connection opening;
a container alignment component releasably connected to the bayonet mount assembly, wherein the container alignment component includes a connection portion disposed within the connection opening;
wherein the connection opening of the bayonet mount assembly includes at least one retaining ledge and the connection portion of the container alignment component includes at least one retaining tab;
wherein the container alignment component is in a first rotational position relative to the bayonet mount assembly and in which the at least one retaining tab is engaged on the at least one retaining ledge to prevent the container alignment component from separating from the bayonet mount assembly by axial movement of the connection portion in a first direction out of the connection opening;
wherein the bayonet mount assembly includes a locking part in a locking position in which a portion of the locking part interacts with a part of the connection portion so as to prevent a rotation of the container alignment component from the first rotational position to a second rotational position that rotationally offsets the at least one retaining tab from the at least one retaining edge;
wherein the locking part is axially movable to an unlocking position that axially offsets the portion of the locking part from the part of the connection portion so as to allow the rotation of the container alignment component from the first rotational position to the second rotational position such that the container alignment component can be separated from the bayonet mount assembly by axial movement of the connection portion in the first direction out of the connection opening.

2. The fill valve assembly of claim 1, wherein the part of the connection portion is the at least one retaining tab.

3. The fill valve assembly of claim 1, wherein the locking part comprises a pin and the portion is a locking detent projecting from the pin, wherein the pin is axially biased into the locking position by a biasing member and is movable to the unlocking position by application of a force on the pin that overcomes the bias of the biasing member.

4. The fill valve assembly of claim 3, wherein the biasing member is a spring and a lower portion of the pin protrudes downwardly from a pin passage of the bayonet mount assembly.

5. The fill valve assembly of claim 4, wherein the bayonet mount assembly comprises a lower retaining plate and an upper cap engaged with the lower retaining plate, wherein the pin passage formed in part on the lower retaining plate and in part on the upper cap.

6. The fill valve assembly of claim 5, wherein the upper cap is configured interact with the at least one retaining tab to limit axial movement of the connection portion in a second direction that is opposite the first direction.

7. The fill valve assembly of claim 1, wherein:
the fill valve assembly includes an upper end;
the bayonet mount assembly is mounted for axial movement along the fill valve assembly between a start position and a raised position;
the bayonet mount assembly is located further from the upper end when the bayonet mount assembly in the start position than when the bayonet mount assembly is in the raised position;
the bayonet mount assembly is biased into the start position.

8. A fill valve assembly for use in association with a filler device, the fill valve assembly comprising:
a bayonet mount assembly including a connection opening;
a container alignment component releasably connected to the bayonet mount assembly, wherein the container alignment component includes a connection portion disposed within the connection opening and in a first rotational position, relative to the bayonet mount assembly, that prevents axial movement of the connection portion out of the connection opening;
wherein the bayonet mount assembly includes a locking part in a locking position in which a portion of the locking part interacts with a part of the connection portion of the container alignment component so as to prevent a rotation of the container alignment component from the first rotational position to a second rotational position that allows axial movement of the connection portion out of the connection opening;
wherein the locking part is manually movable to an unlocking position that allows the rotation of the container alignment component from the first rotational position to the second rotational position.

9. The fill valve assembly of claim 8, wherein the locking part is axially movable between the locking position and the unlocking position.

10. The fill valve assembly of claim 8, wherein the part of the connection portion is a protruding retaining tab.

11. The fill valve assembly of claim 8, wherein:
the fill valve assembly includes an upper end;
the bayonet mount assembly is mounted for axial movement along the fill valve assembly between a start position and a raised position;
the bayonet mount assembly is located further from the upper end when the bayonet mount assembly in the start position than when the bayonet mount assembly is in the raised position;
the bayonet mount assembly is biased into the start position.

12. The fill valve assembly of claim 8, wherein the locking part comprises a pin and the portion is a locking detent projecting from the pin, wherein the pin is axially biased into the locking position by a biasing member and is movable to the unlocking position by application of a force on the pin that overcomes the bias of the biasing member.

13. The fill valve assembly of claim 12, wherein the biasing member is a spring and a lower portion of the pin protrudes downwardly from a pin passage of the bayonet mount assembly.
